(19) United States
(12) Patent Application Publication
(10) Pub. No.: US 2005/0236081 A1
(43) Pub. Date: Oct. 27, 2005

(54) Automotive wheel with a retaining sealing groove

(76) Inventors: Olivier Marsaly, Washington Crossing, PA (US); Jinjun Wang, Piscataway, NJ (US); Larry Rogers, Princeton, NJ (US)

Correspondence Address: Philip K. Fitzsimmons;Shlesinger, Fitzsimmons & Shlesinger, Suite 1323, 183 East Main Street, Rochester, NY, 14604, US

(21) Appl. No.: 10/832,270

(22) Filed: Apr. 27, 2004

(51) Int. Cl. B60C 7/24

(52) U.S. Cl. 152/396

(57) ABSTRACT

A multi-part automotive wheel comprises first and second wheel discs having first and second mating surfaces, respectively, where the first and second discs are to be joined to each other. An annular radial groove is disposed on one of the first and second surfaces for receiving an O-ring for sealing the first surface in respect of the second surface. The groove includes a substantially radial basewall and first and second sidewalls which extend from the basewall toward an intermediate section and from the section toward both edges of the groove, the edges defining a radial groove opening which is smaller than a distance between the sidewalls at the section such that an O-ring having a larger cross-sectional diameter larger than the opening will be retained within the groove prior to the discs being joined together. The basewall merges with the first and second sidewalls with rounded corners to reduce concentration of stress at the corners.

### FIELD OF THE INVENTION

The present invention relates generally to automotive wheels used with pneumatic tubeless tires, and more particularly to wheels of the type that have two or more rims jointed together and sealed by rubber rings.

### BACKGROUND OF THE INVENTION

It has long been customary for some vehicles to employ multiple pieces of rim pieces jointed together by bolts and nuts to form a whole wheel. For these types of wheels, sealing is mandatory on the contact surfaces of the separate rim pieces to prevent air leaking after assembly. Currently, a U-shaped groove shown in FIG. 1, or a dovetail groove shown in FIG. 2, is made on one of the assembly contact surfaces and a rubber ring is placed inside the groove. However, the U-shaped groove cannot hold a rubber ring inside the groove all the time to prevent dropping when the rubber ring is placed in the upper rim piece of the wheel during wheel assembly. Further, the U-shaped groove can cause stress concentration problems at the corners on the groove bottom. The dovetail groove can hold the rubber ring during wheel assembly but makes stress concentration worse due to the sharp corners on the groove bottom. The stress concentrations have led to cracking in the groove areas.

### OBJECTS AND SUMMARY OF THE INVENTION

It is an object of the present invention to provide a wheel with a retaining sealing groove between rim pieces where the groove has a general C-shaped profile to hold a rubber ring all the time during assembly regardless of which rim piece where the groove is located.

It is another object of the present invention to provide a wheel with a retaining sealing groove between rim pieces where the groove has a general C-shaped profile without any sharp corners to lower the stress level within the groove and avoid potential crack occurrence in the groove area.

In summary, the present invention provides an automotive wheel, comprising first and second wheel discs having first and second mating surfaces, respectively, where the first and second discs are to be joined to each other. An annular radial groove is disposed on one of the first and second surfaces for receiving an O-ring for sealing the first surface in respect of the second surface. The groove includes a substantially radial basewall and first and second sidewalls which extend from the basewall toward an intermediate section and from the section toward both edges of the groove, the edges defining a radial groove opening which is smaller than a distance between the sidewalls at the section such that an O-ring having a larger cross-sectional diameter larger than the opening will be retained within the groove prior to the discs being joined together. The basewall merges with the first and second sidewalls with rounded corners to reduce concentration of stress at the corners.

These and other objects of the present invention will become apparent from the following detailed description.

### BRIEF DESCRIPTIONS OF THE DRAWINGS

FIGS. 1 and 2 are prior art groove profiles used in a multi-rim or multi-disc wheel.

FIG. 3 is a fragmentary cross-sectional view of a two-piece automotive wheel incorporating the present invention.

FIG. 4 is an enlarged view of detail A taken from FIG. 3.

FIG. 5 is an enlarged cross-sectional view of a groove made in accordance with the present invention, showing the relationship of an O-ring prior to being inserted within the groove.

FIG. 6 is an enlarged cross-sectional view of the groove made in accordance with the present invention, showing an O-ring disposed within the groove before compression.

FIG. 7 is another embodiment of the groove of FIG. 4, showing an asymmetrical cross-section.

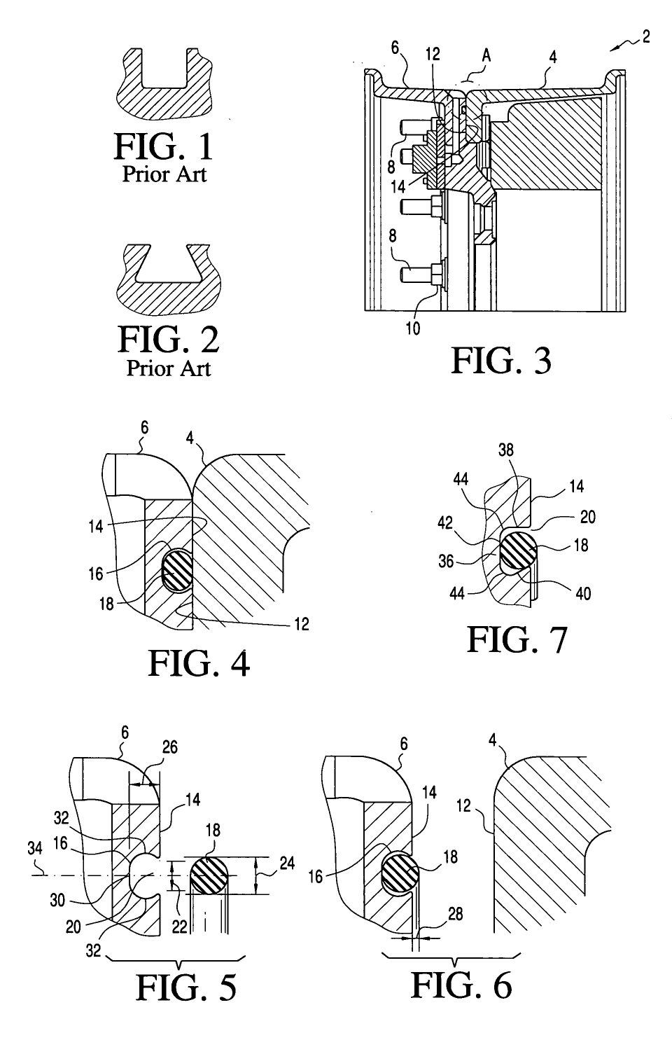

### DETAILED DESCRIPTION OF THE INVENTION

A fragmentary two-piece automotive wheel 2 is disclosed in FIG. 3. The automotive wheel 2 includes an inner rim or disc 4 and an outer rim or disc 6, jointed together by means of a plurality of bolts 8 and nuts 10. The inner and outer rims 4 and 6 are jointed together along opposing mating surfaces 12 and 14. An annular groove 16 is disposed below one of the mating surfaces, such as the mating surface 14. An O-ring 18 is disposed within the groove 16 to seal the mating surfaces 12 and 14 when assembled, as best shown in FIG. 4. The O-ring 18 keeps the air within the tire from leaking out between the mating surfaces 12 and 14. Although a two-piece wheel is disclosed, a person skilled in the art should understand that the present invention is just as applicable to a wheel having more than two rim pieces or discs.

Referring to FIG. 5, the groove 16 has a general C-profile, without any sharp corners, with an opening dimension 22 being less than the diameter 24 of the O-ring 18. The groove 16 also has a depth dimension 26 which is less than the diameter 24 of the O-ring 18.

Referring to FIG. 6, when the O-ring 18 is placed within the groove 16, a portion 28 of the O-ring will extend beyond the surface 14 so that when the surface 12 is pressed against the surface 14, the O-ring 18 will be compressed to provide a seal between the surfaces. Advantageously, once the O-ring is placed within the groove 16, the O-ring will stay within the groove during assembly, since the distance 22 across the opening 20 is less than the diameter 24 of the O-ring, capturing the O-ring within the groove.

Referring again to FIG. 5, the groove 16 has a preferably flat basewall 30 and curving sidewalls 32 that smoothly merge with the basewall 30 to avoid any sharp angles where stress can concentrate. The sidewalls 32 are preferably concave. The sidewalls 32 are further apart from each other at the midsection and closer together near the opening 20. The groove 16 is preferably symmetrical about an axis 34 through the basewall 30 and the opening 20.

Another embodiment of a groove 36 is disclosed in FIG. 7. The groove 36 is asymmetric in cross-section, having a relatively transverse sidewall 38 with respect to the surface 14 and an inwardly inclined sidewall 40 disposed to make the opening 20 smaller than an interior width of the groove. The groove 36 has a basewall 42 that merges with the opposite walls 38 and 40 with rounded corners 44 to advantageously minimize stress concentrations at the corners. The inclined sidewall 40 advantageously holds the O-ring in place during assembly of the wheel 2, since the O-ring is slightly stretched when placed within the groove 36 so as to bear against the inclined sidewall 40 which then tends to bias the O-ring inwardly into the groove. The inclined sidewall 40 is disposed closer to the center of the wheel 2 than the other sidewall 38.

While this invention has been described as having preferred design, it is understood that it is capable of further modification, uses and/or adaptations following in general the principle of the invention and including such departures from the present disclosure as come within known or customary practice in the art to which the invention pertains, and as may be applied to the essential features set forth, and fall within the scope of the invention or the limits of the appended claims.

1. A multi-part automotive wheel, comprising:
a) first and second wheel discs having first and second mating surfaces, respectively;
b) said first and second discs for being joined together along said first and second surfaces;
c) an annular radial groove disposed on one of said first and second surfaces for receiving an O-ring for sealing said first surface in respect of said second surface;
d) said groove including a substantially radial basewall and first and second sidewalls which extend from said basewall toward an intermediate section and from said section toward both edges of said groove, said edges defining a radial groove opening which is smaller than a distance between said sidewalls at said section such that an O-ring having a larger cross-sectional diameter than said opening will be retained within said groove prior to said discs being joined together; and
e) said basewall merging with said first and second sidewalls with rounded corners to reduce concentration of stress at said corners.

2. An automotive wheel as in claim 1, wherein said first and second sidewalls extend outwardly from each other from said basewall toward said section and inwardly from said section toward said edges.

3. An automotive wheel as in claim 1, wherein said sidewalls are concave curving outwardly from each other, said groove being generally C-shaped in cross-section, without any sharp corners.

4. An automotive wheel as in claim 1, wherein:
a) said first sidewall is relatively transverse with respect to said first and second surfaces;
b) said second sidewall is inclined toward said opening such that said opening is smaller than a distance between said sidewalls at said section; and
c) said second sidewall being closer to the center of said wheel.

5. An automotive wheel as in claim 1, wherein said basewall is flat.

6. An automotive wheel as in claim 1, wherein said groove is symmetrical about an axis through said opening and said basewall.

7. An automotive wheel as in claim 1, wherein said groove is asymmetrical about an axis through said opening and said basewall.

8. An automotive wheel as in claim 1, wherein said groove has a depth less than the cross-sectional diameter of said O-ring.
